(19) United States
(12) Patent Application Publication
(10) Pub. No.: US 2026/0214684 A1
(43) Pub. Date: Jul. 23, 2026

(54) TERMINAL APPARATUS AND METHOD

(71) Applicant: SHARP KABUSHIKI KAISHA, Sakai City, Osaka (JP)

(72) Inventors: Takuma KAWANO, Sakai City, Osaka (JP); HIDEKAZU TSUBOI, Sakai City, Osaka (JP); SHOHEI YAMADA, Sakai City, Osaka (JP); TAICHI MIYAKE, Sakai City, Osaka (JP); Kyosuke INOUE, Sakai City, Osaka (JP); Takaki NOMURA, Sakai City, Osaka (JP)

(21) Appl. No.: 19/143,140

(22) PCT Filed: Dec. 6, 2023
(86) PCT No.: PCT/JP2023/043722

§ 371 Date: Jun. 25, 2025

(30) Foreign Application Priority Data
Aug. 3, 2023 (JP) 2023-127013

(51) Int. Cl. H04W 72/25; H04L 47/24

(52) U.S. Cl. CPC H04W 72/25; H04L 47/24

(57) ABSTRACT

A first terminal apparatus capable of sidelink communication communicates with a third terminal apparatus via a second terminal apparatus and transmits to the second terminal apparatus an identifier of a PC5 QoS flow and an identifier of an SL-DRB to which the PC5 QoS flow is mapped, and the SL-DRB is an end-to-end SL-DRB terminated between the first terminal apparatus and the third terminal apparatus.

### TECHNICAL FIELD

The present invention relates to a terminal apparatus and a method.

This application claims priority to Japanese Patent Application No. 2023-127013, filed in Japan on Aug. 3, 2023, the contents of which are incorporated herein by reference.

### BACKGROUND ART

In the 3rd Generation Partnership Project (3GPP) [registered trademark], which is a standardization project for cellular mobile communication systems, technical studies and standardization are being conducted for cellular mobile communication systems, including radio access, a core network, and services.

For example, technical study and standardization of Evolved Universal Terrestrial Radio Access (E-UTRA) have begun in the 3GPP as a Radio Access Technology (RAT) for cellular mobile communication systems for the 3.9th generation and the 4th generation. Technical study and standardization of enhanced technology of E-UTRA are still being carried out in the 3GPP. Note that E-UTRA may also be referred to as Long Term Evolution (LTE: trade name), and its enhanced technology may also be referred to as LTE-Advanced (LTE-A) and LTE-Advanced Pro (LTE-A Pro).

Technical study and standardization of New Radio or NR Radio access (NR) have begun in the 3GPP as a Radio Access Technology (RAT) for cellular mobile communication systems for the 5th Generation (5G). Technical study and standardization of enhanced technology of NR are still being carried out in the 3GPP.

### CITATION LIST

### Non Patent Literature

NPL 1: 3GPP TS 38.331v17.2.0, “Evolved Universal Terrestrial Radio Access (E-UTRA); Radio Resource Control (RRC); Protocol specifications” pp 37-1107

NPL 2: 3GPP TS 38.321v17.1.0, “NR; Medium Access Control (MAC) protocol specification” pp 17-104

NPL 3: 3GPP TS 38.213v17.1.0, “NR; Physical layer procedures for control” pp 14-20

NPL 4: 3GPP TS 38.215v17.1.0, “NR; Physical layer measurements” pp 16-18

NPL 5: 3GPP TS 23.304v17.2.1, “Proximity based Services (ProSe) in the 5G System (5GS)” pp 12-97

NPL 6: 3GPP TS 38.300v17.2.0, “NR; NR and NG-RAN Overall Description” pp 31-170

NPL 7: RP-221262, “Revised WID on NR sidelink relay enhancements”

NPL 8: 3GPP TR 23.700-33 v1.1.0, “Study on system enhancement for Proximity based Services (ProSe) in the 5G System (5GS); Phase 2”

NPL 9: 3GPP TS 23.501v17.2.0, “System architecture for the 5G System (5GS); Stage 2”

NPL 10: 3GPP TS 23.287v17.2.0, “Architecture enhancements for 5GSystem (5GS) to support Vehicle-to-Everything (V2X) services”

NPL 11: 3GPP TS 37.324v17.0.0, “E-UTRA and NR; Service Data Adaptation Protocol (SDAP) specification”

### SUMMARY OF INVENTION

### Technical Problem

In the 3GPP, as an extended technique of NR, a technique called a sidelink has been studied in which a terminal apparatus and a terminal apparatus directly communicate with each other without an intervening core network. Furthermore, a technique (UE-to-UE relay) has started to be studied in which another terminal apparatus is added between the terminal apparatuses and communication among these terminal apparatuses is supported.

An aspect of the present invention is made in view of the circumstances described above, and an object of the present invention is to provide a terminal apparatus, a communication method, and an integrated circuit capable of efficient communication control.

### Solution to Problem

In order to accomplish the object described above, an aspect of the present invention is contrived to provide the following means. That is, an aspect of the present invention is a first terminal apparatus capable of sidelink communication, including a transmitter, wherein the first terminal apparatus communicates with a third terminal apparatus via a second terminal apparatus, the transmitter transmits to the second terminal apparatus an identifier of a PC5 QoS flow and an identifier of an SL-DRB to which the PC5 QoS flow is mapped, and the SL-DRB is an end-to-end SL-DRB terminated between the first terminal apparatus and the third terminal apparatus.

Further, an aspect of the present invention is a second terminal apparatus capable of sidelink communication, including: a processor; a transmitter; and a receiver configured to receive first information from a first terminal apparatus, wherein the first terminal apparatus communicates with a third terminal apparatus via the second terminal apparatus, the first information includes an identifier of a PC5 QoS flow and an identifier of an SL-DRB to which the PC5 QOS flow is mapped, the processor configures a mapping rule between the SL-DRB to which the PC5 QoS flow is mapped and an RLC channel of the second terminal apparatus based on the first information, and the SL-DRB is an end-to-end SL-DRB terminated between the first terminal apparatus and the third terminal apparatus.

Further, an aspect of the present invention is a method for a first terminal apparatus capable of sidelink communication, including: communicating, by the first terminal apparatus, with a third terminal apparatus via a second terminal apparatus; and transmitting to the second terminal apparatus an identifier of a PC5 QoS flow and an identifier of an SL-DRB to which the PC5 QOS flow is mapped, wherein the SL-DRB is an end-to-end SL-DRB terminated between the first terminal apparatus and the third terminal apparatus.

These comprehensive or specific aspects may be realized as a system, an apparatus, a method, an integrated circuit, a computer program, or a recording medium, or may be realized as any combination of a system, an apparatus, a method, an integrated circuit, a computer program, and a recording medium.

### Advantageous Effects of Invention

According to an aspect of the present invention, the terminal apparatus, the method, and the integrated circuit can realize efficient communication control processing.

### BRIEF DESCRIPTION OF DRAWINGS

FIG. 1 is a schematic diagram of a communication system according to the present embodiment.

FIG. 2 is a diagram of an example of a protocol architecture for NR sidelink communication according to the present embodiment.

FIG. 3 is a diagram of an example of a protocol architecture for NR sidelink communication according to the present embodiment.

FIG. 4 is a diagram of an example of a protocol architecture of a sidelink according to the present embodiment.

FIG. 5 is a block diagram showing a configuration of a terminal apparatus according to the present embodiment.

FIG. 6 is a diagram of an example of a protocol architecture of a sidelink according to the present embodiment.

FIG. 7 is a diagram of an example of a protocol architecture of a sidelink according to the present embodiment.

FIG. 8 is an example of processing in the present embodiment.

### DESCRIPTION OF EMBODIMENTS

The present embodiment will be described below in detail with reference to the drawings.

Note that, in the present embodiment, terms of each node and entity, processing in each node and entity, and the like in a case that the radio access technology is NR and E-UTRA will be described. However, the present embodiment may be applied to another radio access technology. In the present embodiment, the terms of each node and entity may be other terms.

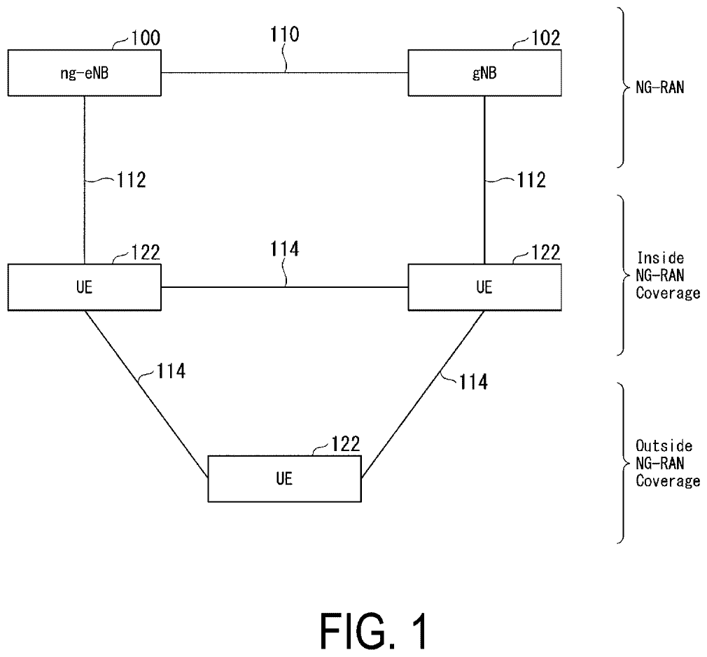

FIG. 1 is a schematic diagram of a communication system according to the present embodiment. Note that functions such as each node, radio access technology, core network, and interface to be described with reference to FIG. 1 are a part of functions closely related to the present embodiment, and other functions may be provided.

E-UTRA may be a radio access technology. The E-UTRA may be an air interface between a UE 122 and an ng-eNB 100. The air interface 112 between the UE 122 and the ng-eNB 100 may be referred to as a Uu interface. The ng-eNB (ng E-UTRAN Node B) 100 may be a base station apparatus of the E-UTRAN. The ng-eNB 100 may have an E-UTRA protocol to be described below. The E-UTRA protocol may include an E-UTRA User Plane (UP) protocol to be described below and an E-UTRA Control Plane (CP) protocol to be described below. The ng-eNB 100 may terminate the E-UTRA user plane protocol and the E-UTRA control plane protocol for the UE 122. A radio access network including the eNB may be referred to as an E-UTRAN.

NR may be a radio access technology. The NR may be an air interface between the UE 122 and a gNB 102. The air interface 112 between the UE 122 and the gNB 102 may be referred to as a Uu interface. The g Node B (gNB) 102 may be a base station apparatus of NR. The gNB 102 may have an NR protocol to be described below. The NR protocol may include an NR User Plane (UP) protocol to be described below and an NR Control Plane (CP) protocol to be described below. The gNB 102 may terminate the NR user plane protocol and the NR control plane protocol for the UE 122.

Note that the interface 110 between the ng-eNB 100 and the gNB 102 may be referred to as an Xn interface. The ng-eNB and the gNB may be connected to the 5GC via an interface called an NG interface (not illustrated). The 5GC may be a core network. One or multiple base station apparatuses may connect to the 5GC via the NG interface.

A state in which a connection to the base station apparatus can be made only via the Uu interface may be called Inside NG-RAN coverage or In-Coverage (IC). Furthermore, a state in which the connection to the base station apparatus cannot be made only via the Uu interface may be called Outside NG-RAN coverage or Out-of-Coverage (OoC). An air interface 114 between the UE 122 and the UE 122 may be called a PC5 interface. Communication between the UEs 122 via the PC5 interface may be referred to as sidelink (SL) communication. A terminal apparatus that can perform sidelink communication may be referred to as a terminal apparatus capable of sidelink communication.

Note that, in the following description, the ng-eNB 100 and/or the gNB 102 is also simply referred to as a base station apparatus, and the UE 122 is also simply referred to as a terminal apparatus or a UE. The PC5 interface is also simply referred to as PC5, and the Uu interface is also simply referred to as Uu.

The sidelink is a technology for direct communication between terminal apparatuses via PC5, and sidelink transmission and/or reception on the PC5 is performed inside and outside the NG-RAN coverage.

NR SL communication has three transmission modes, and SL communication is performed in one of the transmission modes with a pair of a source layer-2 identifier (source layer-2 (L2) ID) and a destination layer-2 identifier (destination layer-2 (L2) ID). A source layer-2 identifier and a destination layer-2 identifier may be referred to as a source L2ID and a destination L2ID, respectively. The three transmission modes are “unicast transmission”, “groupcast transmission”, and “broadcast transmission”. The transmission mode may also be referred to as a cast type, or the like. The unicast transmission for direct communication is supported on the PC5, and a PC5 unicast link between two UEs may be established for direct communication. Further, the PC5 unicast link may also be maintained, changed, or released according to a request for an application layer or communication requirements.

The unicast transmission is characterized by: (1) support of one PC5-RRC connection between paired UEs; (2) transmission and/or reception of control information and user traffic between UEs on the sidelink; (3) support of sidelink HARQ feedback; (4) transmission power control on the sidelink; (5) support of RLC AM; and (6) detection of radio link failure for the PC5-RRC connection.

The groupcast transmission is characterized by (1) transmission and/or reception of user traffic between UEs belonging to a sidelink group and (2) support of sidelink HARQ feedback.

The broadcast transmission is characterized by (1) transmission and/or reception of user traffic between UEs on the sidelink.

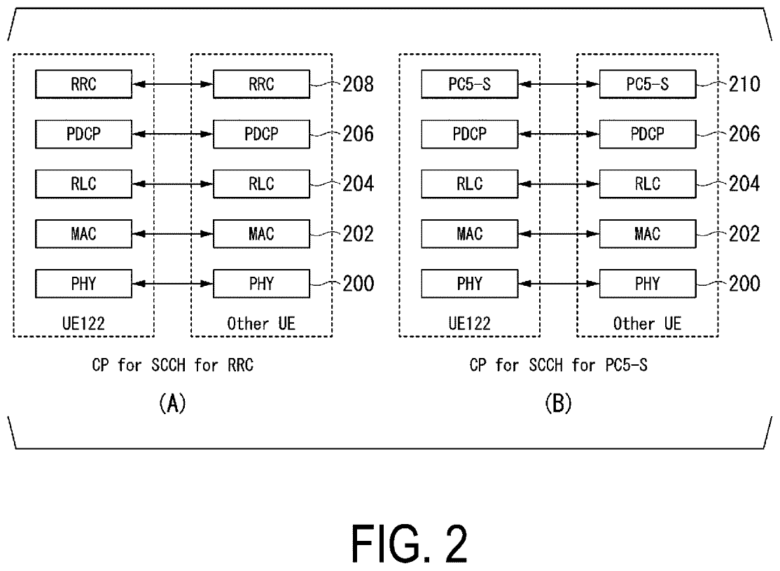

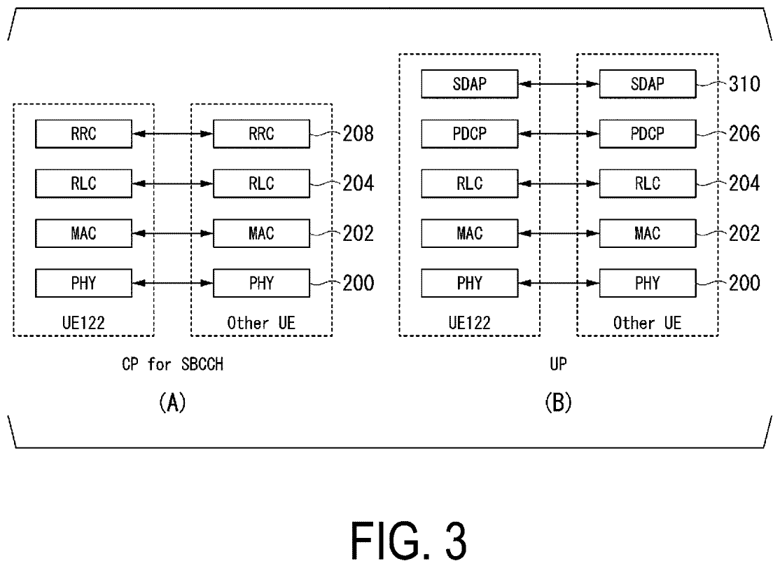

FIGS. 2 and 3 are diagrams of an example of a protocol architecture in NR sidelink communication according to the present embodiment. Note that functions of each protocol to be described with reference to FIG. 2 and/or FIG. 3 are a part of functions closely related to the present embodiment, and other functions may be provided. Note that, in the present embodiment, the sidelink (SL) may be a link between a terminal apparatus and a terminal apparatus.

FIG. 2(A) is a diagram of a protocol stack of the Control Plane (CP) for an SCCH with RRC, which is configured on the PC5 interface. As illustrated in FIG. 2(A), the control plane protocol stack for the SCCH with RRC may include a Physical layer (PHY) 200 which is a radio physical layer, a Medium Access Control (MAC) 202 which is a medium access control layer, a Radio Link Control (RLC) 204 which is a radio link control layer, and a Packet Data Convergence Protocol (PDCP) 206 which is a packet data convergence protocol layer, and a Radio Resource Control (RRC) 208 which a radio resource control layer. FIG. 2(B) is a diagram of the protocol stack of the control plane for the SCCH with PC5-S, which is configured on the PC5 interface. As illustrated in FIG. 2(B), the control plane protocol stack for the SCCH with PC5-S may include the Physical layer (PHY) 200 which is a radio physical layer, the Medium Access Control (MAC) 202 which is a medium access control layer, the Radio Link Control (RLC) 204 which is a radio link control layer, and the Packet Data Convergence Protocol (PDCP) 206 which is a packet data convergence protocol layer, and a PC5 Signalling (PC5-S) 210 which is a PC5 signalling layer.

FIG. 3(A) is a diagram of the protocol stack of the control plane for an SBCCH, which is configured on the PC5 interface. As illustrated in FIG. 3(A), the control plane protocol stack for the SBCCH may include the Physical layer (PHY) 200 which is a radio physical layer, the Medium Access Control (MAC) 202 which is a medium access control layer, the Radio Link Control (RLC) 204 which is a radio link control layer, and the Radio Resource Control 208 (RRC) which is a radio resource control layer. FIG. 3(B) is a diagram of the protocol stack of the User Plane (UP) for an STCH, which is configured on the PC5 interface. As illustrated in FIG. 3(B), the control plane protocol stack for the STCH may include the Physical layer (PHY) 200 which is a radio physical layer, the Medium Access Control (MAC) 202 which is a medium access control layer, the Radio Link Control (RLC) 204 which is a radio link control layer, the Packet Data Convergence Protocol (PDCP) 206 which is a packet data convergence protocol layer, and a Service Data Adaptation Protocol (SDAP) 310 which is a service data adaptation protocol layer.

The access stratum (AS) layer may be a layer that includes some or all of PHY 200, MAC 202, RLC 204, SRAP 600, PDCP 206, SDAP 310, and RRC 208. Also, the PC5-S 210 and the discovery 400, which will be described later, may be layers above the AS layer.

Note that the present embodiment may use terms such as a PHY (PHY layer), a MAC (MAC layer), an RLC (RLC layer), a PDCP (PDCP layer), an SDAP (SDAP layer), an RRC (RRC layer), and a PC5-S (PC5-S layer). In this case, the PHY (PHY layer), the MAC (MAC layer), the RLC (RLC layer), the PDCP (PDCP layer), the SDAP (SDAP layer), the RRC (RRC layer), and the PC5-S (PC5-S layer) may respectively be the PHY (PHY layer), the MAC (MAC layer), the RLC (RLC layer), the PDCP (PDCP layer), the SDAP (SDAP layer), the RRC (RRC layer), and the PC5-S (PC5-S layer) of the NR sidelink protocol. In a case that sidelink communication is performed using the E-UTRA technology, the SDAP layer need not be provided. In order to clarify that the protocol is for sidelink, for example, the RLC may be expressed as a sidelink RLC, SL RLC, PC5 RLC, or the like, and for other protocols, the protocols may be expressed as protocols for sidelink by adding “sidelink”, “SL”, or “PC5” to a beginning.

In addition, in the present embodiment, in a case that the E-UTRA protocol is distinguished from the NR protocol, PHY, MAC, RLC, PDCP, and RRC may be referred to as PHY for E-UTRA or PHY for LTE, MAC for E-UTRA or MAC for LTE, RLC for E-UTRA or RLC for LTE, PDCP for E-UTRA or PDCP for LTE, and RRC for E-UTRA or RRC for LTE, respectively. In addition, PHY, MAC, RLC, PDCP, and RRC may be described as E-UTRA PHY or LTE PHY, E-UTRA MAC or LTE MAC, E-UTRA RLC or LTE RLC, E-UTRA PDCP or LTE PDCP, and E-UTRA RRC or LTE RRC, respectively. Further, in a case that the E-UTRA protocol is distinguished from the NR protocol, PHY, MAC, RLC, PDCP, and RRC may be referred to as PHY for NR, MAC for NR, RLC for NR, RLC for NR, and RRC for NR, respectively. Further, PHY, MAC, RLC, PDCP, and RRC may be described as NR PHY, NR MAC, NR RLC, NR PDCP, and NR RRC, respectively.

Entities in the AS layer of E-UTRA and/or NR will be described. An entity having a part or all of functions of the physical layer may be referred to as a PHY entity. An entity having a part or all of functions of the MAC layer may be referred to as a MAC entity. An entity having a part or all of functions of the RLC layer may be referred to as an RLC entity. An entity having a part or all of functions of the PDCP layer may be referred to as a PDCP entity. An entity having a part or all of functions of the SDAP layer may be referred to as an SDAP entity. An entity having a part or all of functions of the RRC layer may be referred to as an RRC entity. The PHY entity, the MAC entity, the RLC entity, the PDCP entity, the SDAP entity, and the RRC entity may respectively be replaced with a PHY, a MAC, an RLC, a PDCP, an SDAP, and an RRC.

Note that data provided from the MAC, the RLC, the PDCP, and the SDAP to a lower layer, and/or data provided to the MAC, the RLC, the PDCP, and the SDAP from a lower layer may be referred to as a MAC Protocol Data Unit (PDU), an RLC PDU, a PDCP PDU, and an SDAP PDU, respectively. Data provided to the MAC, the RLC, the PDCP, and the SDAP from a higher layer, and/or data provided from the MAC, the RLC, the PDCP, and the SDAP to a higher layer may be referred to as a MAC Service Data Unit (SDU), an RLC SDU, a PDCP SDU, and an SDAP SDU, respectively. A segmented RLC SDU may be referred to as an RLC SDU segment.

Here, the base station apparatus and the terminal apparatus exchange (transmit and/or receive), over the Uu interface, signals with each other in higher layers. The higher layer may be referred to as an upper layer, and may be paraphrased with each other. For example, the base station apparatus and the terminal apparatus may transmit and/or receive an RRC message (also referred to as RRC signalling) in a Radio Resource Control (RRC) layer. In a Medium Access Control (MAC) layer, the base station apparatus and the terminal apparatus may transmit and/or receive a MAC Control Element (MAC CE). Additionally, the RRC layer of the terminal apparatus acquires system information broadcast from the base station apparatus. In this regard, the RRC message, the system information, and/or the MAC control element are also referred to as higher layer signaling or a higher layer parameter. Each of the parameters included in the higher layer signaling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, an RLC layer, a PDCP layer, a Non Access Stratum (NAS) layer, and the like. For example, in the processing of the MAC layer, the higher layer may mean one or multiple of the RRC layer, the RLC layer, the PDCP layer, the NAS layer, and the like.

The terminal apparatuses exchange (transmit and/or receive), over the PC5 interface, signals with each other in higher layers. The terminal apparatuses may transmit and/or receive an RRC message (also referred to as RRC signalling) in the Radio Resource Control (RRC) layer. In the Medium Access Control (MAC) layer, the terminal apparatuses may transmit and/or receive a MAC Control Element (MAC CE). In this regard, the RRC message and/or the MAC control element are also referred to as higher layer signaling or a higher layer parameter. Each of the parameters included in the higher layer signaling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, the RLC layer, the PDCP layer, the PC5-S layer, the Discovery layer, and the like. For example, in the processing of the MAC layer, the higher layer may mean one or multiple of the RRC layer, the RLC layer, the PDCP layer, the PC5-S layer, the Discovery layer, and the like.

Hereinafter, “A is given (provided) in the higher layer” or “A is given (provided) by the higher layer” may mean that the higher layer (mainly the RRC layer, the MAC layer, or the like) of the terminal apparatus receives A from the base station apparatus or another terminal apparatus, and that the received A is given (provided) from the higher layer of the terminal apparatus to the physical layer of the terminal apparatus. For example, “a higher layer parameter being provided” in the terminal apparatus may mean that higher layer signaling is received from the base station apparatus or another terminal apparatus, and a higher layer parameter included in the received higher layer signaling is provided from the higher layer of the terminal apparatus to the physical layer of the terminal apparatus. A higher layer parameter being configured for the terminal apparatus may mean that the higher layer parameter is given (provided) to the terminal apparatus. For example, a higher layer parameter being configured for the terminal apparatus may mean that the terminal apparatus receives higher layer signaling from the base station apparatus or another terminal apparatus and configures the received higher layer parameter in the higher layer. However, a higher layer parameter being configured for the terminal apparatus may include a default parameter given in advance being configured in the higher layer of the terminal apparatus. In description of transmission of an RRC message from the terminal apparatus to the base station apparatus or another terminal apparatus, the expression that a message is submitted from the RRC entity of the terminal apparatus to a lower layer may be used. In the terminal apparatus, “submitting a message to a lower layer” from the RRC entity may mean submitting a message to the PDCP layer. In the terminal apparatus, “submitting a message to a lower layer” from the RRC layer may mean submitting the message of the RRC to a PDCP entity corresponding to each SRB (SRB0, SRB1, SRB2, SRB3, or the like) because the message is transmitted using the SRB. In a case that the RRC entity of the terminal apparatus receives an indication from the lower layer, the lower layer may mean one or more of a PHY layer, a MAC layer, an RLC layer, a PDCP layer, and the like.

An example of the functions of the PHY will be described. The PHY of the terminal apparatus may have a function of transmitting and/or receiving transmitted data to and/or from the PHY of another terminal apparatus via a sidelink (SL) Physical Channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Here, physical channels will be described. The physical channels used for wireless communication between a terminal apparatus and another terminal apparatus may include the following physical channels.

Physical Sidelink Broadcast CHannel (PSBCH)

Physical Sidelink Control CHannel (PSCCH)

Physical Sidelink Shared CHannel (PSSCH)

Physical Sidelink Feedback CHannel (PSFCH)

The PSBCH may be used to broadcast system information required by the terminal apparatus.

The PSCCH may be used to indicate resources or other transmission parameters for the PSSCH.

The PSSCH may be used to transmit data and control information related to HARQ/CSI feedback to another terminal apparatus.

The PSFCH may be used to carry HARQ feedback to another terminal apparatus.

An example of the functions of the MAC will be described. The MAC may be referred to as a MAC sublayer. The MAC may have a function of mapping various Logical Channels to their corresponding transport channels. The logical channel may be identified with a Logical Channel Identity (or Logical Channel ID). The MAC may be connected to an upper RLC with a logical channel. The logical channel may be classified into a control channel for transmitting control information and a traffic channel for transmitting user information depending on the type of information to be transmitted. The MAC may have a function of multiplexing MAC SDUs belonging to one or multiple different logical channels and providing the multiplexed MAC SDUs to the PHY. The MAC may have a function of demultiplexing the MAC PDUs provided from the PHY and providing the demultiplexed MAC PDUs to a higher layer via the logical channels to which the respective MAC SDUs belong. The MAC may have a function of performing error correction through a Hybrid Automatic Repeat reQuest (HARQ). The MAC may have a function of reporting scheduling information. The MAC may have a function of performing priority processing among the terminal apparatuses by using dynamic scheduling.

The MAC may have a function of performing priority processing among the logical channels in one terminal apparatus. The MAC may have a function of performing priority processing of resources overlapping in one terminal apparatus. The E-UTRA MAC may have a function of identifying Multimedia Broadcast Multicast Services (MBMS). The NR MAC may have a function of identifying a Multicast Broadcast Service (MBS). The MAC may have a function of selecting a transport format. The MAC may have a function of performing Discontinuous Reception (DRX) and/or Discontinuous Transmission (DTX), a function of performing a Random Access (RA) procedure, a Power Headroom Report (PHR) function of reporting information of transmittable power, a Buffer Status Report (BSR) function of reporting data volume information of a transmission buffer, and the like. The NR MAC may have a Bandwidth Adaptation (BA) function. A MAC PDU format used in the E-UTRA MAC and a MAC PDU format used in the NR MAC may be different from each other. The MAC PDU may include a MAC control element (MAC CE) being an element for performing control in the MAC.

The MAC sublayer may additionally provide, on the PC5 interface, services and functions, such as radio resource selection for selecting a radio resource for sidelink transmission, filtering of packets received through sidelink communication, priority processing between the uplink and the sidelink, reporting of Sidelink Channel State Information (Sidelink CSI).

Mapping, which is used in E-UTRA and/or NR, between a sidelink (SL) logical channel and a sidelink logical channel and a transport channel will be described.

A Sidelink Broadcast Control Channel (SBCCH) may be a sidelink logical channel for broadcasting sidelink system information from one terminal apparatus to one or multiple terminal apparatuses. The SBCCH may be mapped to an SL-BCH that is a sidelink transport channel.

A Sidelink Control Channel (SCCH) may be a sidelink logical channel for transmitting control information such as a PC5-RRC message and a PC5-S message from one terminal apparatus to one or multiple terminal apparatuses. The SCCH may be mapped to an SL-SCH that is a sidelink transport channel.

A Sidelink Traffic Control Channel (STCH) may be a sidelink logical channel for transmitting user information from one terminal apparatus to one or multiple terminal apparatuses. The STCH may be mapped to the SL-SCH that is a sidelink transport channel.

An example of the functions of the RLC will be described. The RLC may be referred to as an RLC sublayer. The E-UTRA RLC may have a function of segmenting (Segmentation) and/or concatenating (Concatenation) data provided from the PDCP of a higher layer, and providing the segmented and/or concatenated data to a lower layer. The E-UTRA RLC may have a function of reassembling (reassembly) and re-ordering data provided from a lower layer, and providing the reassembled and re-ordered data to a higher layer. The NR RLC may have a function of assigning data provided from the PDCP of a higher layer with a sequence number independent of a sequence number assigned in the PDCP. The NR RLC may have a function of segmenting (Segmentation) data provided from the PDCP and providing the segmented data to a lower layer. The NR RLC may have a function of reassembling (reassembly) data provided from a lower layer, and providing the reassembled data to a higher layer. The RLC may have a data retransmission function and/or retransmission request function (AutomaticRepeat reQuest (ARQ)). The RLC may have a function of performing error correction using the ARQ. Control information that indicates data required to be retransmitted and that is transmitted from a receiving side to a transmitting side of the RLC in order to perform the ARQ may be referred to as a status report. A status report transmission indication transmitted from the transmitting side to the receiving side of the RLC may be referred to as a poll. The RLC may have a function of detecting data duplication. The RLC may have a function of discarding data. The RLC may have three modes, namely a Transparent Mode (TM), an Unacknowledged Mode (UM), and an Acknowledged Mode (AM). In the TM, segmentation of data received from a higher layer may not be performed, and addition of an RLC header need not be performed. A TM RLC entity may be a uni-directional entity, and may be configured as a transmitting TM RLC entity or as a receiving TM RLC entity. In the UM, segmentation and/or concatenation of data received from a higher layer, addition of an RLC header, and the like may be performed, but retransmission control of data need not be performed. A UM RLC entity may be a uni-directional entity, or may be a bi-directional entity. In a case that the UM RLC entity is a uni-directional entity, the UM RLC entity may be configured as a transmitting UM RLC entity or as a receiving UM RLC entity. In a case that the UM RLC entity is a bi-directional entity, the UM RRC entity may be configured as a UM RLC entity including a transmitting side and a receiving side. In the AM, segmentation and/or concatenation of data received from a higher layer, addition of an RLC header, retransmission control of data, and the like may be performed. An AM RLC entity may be a bi-directional entity, and may be configured as an AM RLC including a transmitting side and a receiving side. Note that data provided to a lower layer and/or data provided from a lower layer in the TM may be referred to as a TMD PDU. Data provided to a lower layer and/or data provided from a lower layer in the UM may be referred to as a UMD PDU. Data provided to a lower layer or data provided from a lower layer in the AM may be referred to as an AMD PDU. An RLC PDU format used in the E-UTRA RLC and an RLC PDU format used in the NR RLC may be different from each other. The RLC PDU may include an RLC PDU for data and an RLC PDU for control. The RLC PDU for data may be referred to as an RLC DATA PDU (RLC Data PDU, RLC data PDU). The RLC PDU for control may be referred to as an RLC CONTROL PDU (RLC Control PDU, RLC control PDU). A control RLC PDU used for transmission of the status report may be referred to as a status PDU (STATUS PDU).

Note that, in the sidelink, the TM may be used for the SBCCH, only the UM is used in groupcast transmission and broadcast transmission, and the UM and the AM can be used in unicast transmission. In the sidelink, the UM in groupcast transmission and broadcast transmission supports only unidirectional transmission.

An example of the functions of the PDCP will be described. The PDCP may be referred to as a PDCP sublayer. The PDCP may have a function of maintenance of the sequence number. The PDCP may have a header compression and decompression function for efficiently transmitting, in wireless sections, user data such as an IP Packet and an Ethernet frame. A protocol used for header compression and decompression for an IP packet may be referred to as a Robust Header Compression (ROHC) protocol. A protocol used for header compression and decompression for an Ethernet frame may be referred to as an Ethernet (trade name) Header Compression (EHC) protocol. The PDCP may have a function of encrypting and decrypting data. The PDCP may have a function of data integrity protection and integrity verification. The PDCP may have a function of re-ordering. The PDCP may have a function of retransmitting the PDCP SDU. The PDCP may have a function of discarding data using a discard timer. The PDCP may have a Duplication function. Further, the PDCP may have a function of discarding pieces of data received in a duplicate manner. The PDCP entity may be a bi-directional entity, and may include a transmitting PDCP entity and a receiving PDCP entity. A PDCP PDU format used in the E-UTRA PDCP and a PDCP PDU format used in the NR PDCP may be different from each other. The PDCP PDU may include a PDCP PDU for data and a PDCP PDU for control. The PDCP PDU for data may be referred to as a PDCP DATA PDU (PDCP Data PDU, PDCP data PDU). The PDCP PDU for control may be referred to as a PDCP CONTROL PDU (PDCP Control PDU, PDCP control PDU).

Note that, in the sidelink, there are the following restrictions on the functions and services of the PDCP.
(1) Out-of-order delivery may be supported exclusively in unicast transmission.
(2) Duplication on the PC5 interface is not supported.

An example of the functions of the SDAP will be described. The SDAP is a service data adaptation protocol layer. In the sidelink, SDAP may have a function of mapping a sidelink QoS flow (PC5 QoS flow) sent from a terminal apparatus to another terminal apparatus with a sidelink data radio bearer (SL-DRB). The SDAP may also have a function of storing mapping rule information. The SDAP may also have a function of marking a QoS flow identifier (QoS Flow ID: QFI) and a PC5 QOS flow identifier (PC5 QOS Flow ID: PQFI or PFI). The SDAP PDU may include a data SDAP PDU and a control SDAP PDU. The SDAP PDU for data may be referred to as an SDAP DATA PDU (SDAP Data PDU, SDAP data PDU). The SDAP PDU for control may be referred to as an SDAP CONTROL PDU (SDAP Control PDU, SDAP control PDU). In the sidelink, one SDAP entity of the terminal apparatus may exist for each destination for unicast transmission, groupcast transmission, and broadcast transmission associated with a destination. Reflective QoS is not supported on the PC5 interface.

An example of the functions of the RRC will be described. RRC may support services and functions on the PC5 interface such as forwarding of PC5-RRC messages between peer UEs, maintenance and release of the PC5-RRC connection between two UEs, and detection of a failure in sidelink radio link for PC5-RRC connection. The PC5-RRC connection is considered to be a logical connection between two UEs corresponding to a pair of a source L2ID and a destination L2ID and to be established after a corresponding PC5 unicast link is established. There is a one-to-one correspondence between the PC5-RRC connection and the PC5 unicast link. The UE may have multiple PC5-RRC connections to one or multiple UEs for different pairs of source L2IDs and destination L2IDs. A separate PC5-RRC procedure and separate messages may be used for the UE to transfer UE capabilities and sidelink configurations to peer UE. Both peer UEs may exchange the UE capabilities and sidelink configurations thereof with each other using a separate bi-directional procedure. In a case of being uninterested in the sidelink transmission, the UE releases the PC5-RRC connection in a case that a failure in sidelink radio link for the PC5-RRC connection is detected and that the Layer-2 link release procedure is completed.

A UE that performs the sidelink transmission may transmit a PSCCH and a PSSCH in association with each other. The sidelink transmission may be transmitting a signal and/or data (message) via a physical channel for the sidelink (PSBCH, PSSCH, PSCCH, or the like), and the sidelink reception may be receiving a signal and/or data (message) via the physical channel for the sidelink. In addition, communication using the sidelink transmission and the sidelink reception may be referred to as sidelink communication. The UE may recognize the data (message) based on the signal. Each PSSCH transmission may be associated with a certain PSCCH (a PSCCH) transmission. The PSCCH transmission may carry a first SCI (first stage of SCI) associated with a PSSCH transmission, and a second SCI (second stage of SCI) may be carried within the resources of the PSSCH. The PSCCH transmission may include the first SCI, and the PSSCH transmission may include the second SCI. Further, the PSCCH and PSSCH transmissions may be referred to as sidelink transmissions, and the SCI may be sidelink control information. The first SCI may include information in a format called SCI format 1-A, and may be used for scheduling of the PSSCH and the second SCI on the PSSCH. The SCI format 1-A may include information such as data priority, frequency and time resources on which the PSSCH is transmitted, resource reservation period, DMRS arrangement pattern, second SCI format, beta offset indication value, number of DMRS ports, and information indicating modulation and coding scheme, and may include other information. In addition, the SCI carried on the PSSCH may be the second SCI, and the second SCI may transport sidelink scheduling information and/or information related to inter-UE coordination. The second SCI may include information in a format called SCI format 2-A, SCI format 2-B, or SCI format 2-C. SCI format 2-A, SCI format 2-B, and SCI format 2-C may include information such as HARQ process related information, information indicating whether data is new, redundancy version, source ID for identifying a source UE, destination ID for identifying a destination UE, and information indicating whether HARQ feedback is possible. Further, SCI format 2-A may additionally include information indicating a cast type and information indicating whether channel state information (CSI: Channel State Information) is requested. Further, SCI format 2-B may additionally include an identifier indicating a zone and request information on a communication range. Further, SCI format 2-C may additionally include information indicating whether channel state information is requested and information indicating whether inter-UE coordination information is provided or requested. In a case that SCI format 2-C includes information for providing UE-to-UE coordination information, SCI format 2-C may additionally include information such as information indicating a resource combination, information indicating a first resource position, position information of a reference slot, information indicating a type of a resource set, and a lowest subchannel index. In a case that SCI format 2-C includes information for requesting UE-to-UE coordination information, SCI format 2-C may additionally include information such as a priority, a number of subchannels, a resource reservation interval, a position of a resource selection window, and information indicating a type of a resource set. Each SCI format may include information other than the above-described information.

Next, a procedure of the UE receiving a PSSCH will be described. In a case that the UE detects SCI format 1-A on the PSCCH, the UE can decode the PSSCH according to the detected SCI format 2-A or SCI format 2-B and the associated PSSCH resource configuration configured by a higher layer. The UE does not need to decode more than one PSCCH in each PSCCH resource candidate. In addition, in a case that the UE does not support the modulation and coding scheme indicated in SCI format 1-A, the UE does not need to decode the corresponding SCI format 2-A and SCI format 2-B, and the PSSCH associated with SCI format 1-A.

In addition, in a case that the PSSCH is configured in the parameter indicating whether the DMRS used for L1 RSRP measurement during the sensing operation is the DMRS of the PSCCH or the DMRS of the PSSCH in an upper (RRC) layer, the UE may measure the PSSCH RSRP from the DMRS resource element for the PSSCH associated with the received SCI format 1-A, and in a case that the PSCCH is configured, the UE may measure the PSCCH RSRP from the DMRS resource element for the PSCCH associated with the received SCI format 1-A.

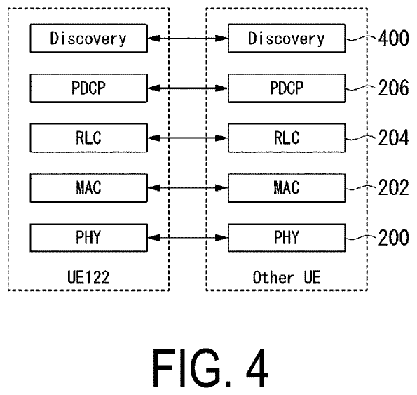

A terminal apparatus capable of sidelink communication may perform discovery. Discovery may include Model A and Model B. FIG. 4 shows a protocol stack in the discovery procedure. Model A may use a single discovery protocol message, and Model B may use two discovery protocol messages. The single discovery protocol message in Model A may be an Announcement message, and the discovery protocol message in Model B may include a Solicitation message and a Response message. The announcement message, solicitation message, and response message may be collectively referred to as a discovery message, and a message with another name used in the discovery procedure may be referred to as a discovery message. Hereinafter, an overview of procedures of Model A and Model B in ProSe Direct Discovery will be shown.

In Model A, the UE that transmits an announcement message may be referred to as an announcing UE, and the UE that monitors the announcement message may be referred to as a monitoring UE. The announcement message may include information such as a discovery message type, a ProSe Application Code or a ProSe Restricted Code, a security protection element, and may additionally include metadata information. The announcement message is transmitted using a Destination Layer-2 ID (destination L2ID) and a Source Layer-2 ID (source L2ID), and the monitoring UE determines the destination L2ID to receive the announcement message. Note that the destination L2ID may be a Layer-2 identifier of the destination UE, and the source L2ID may be a Layer-2 identifier of the source UE. The destination UE may be simply referred to as a destination.

In Model B, the UE that transmits a solicitation message may be referred to as a discoverer UE, and the UE that receives the solicitation message and/or transmits a response message to the discoverer UE may be referred to as a discoveree UE. The solicitation message may include information such as a type of the discovery message, a ProSe Query Code, and a security protection element. The solicitation message is transmitted using the destination L2ID and the source L2ID, and the discoveree UE determines the destination L2ID to receive the solicitation message. The discoveree UE responding to the solicitation message transmits the response message. The response message may include information such as the discovery message type, a ProSe Response Code, and the security protection element, and may additionally include metadata information. The response message is transmitted using the source L2ID, and the destination L2ID is set to the source L2ID of the received solicitation message.

There may be types of discovery other than ProSe direct discovery which discovers other UEs in order to perform direct communication with the other UEs, and there may be group member discovery which discovers one or more UEs in order to perform communication within a group using a sidelink, and 5G ProSe UE-to-Network Relay Discovery which discovers candidate relay UEs in order to connect to a network via a relay UE. The above-described discovery is an example of discovery provided by an application called ProSe, but there may be different types of discovery depending on an application or service performing the sidelink communication, in addition to the above-described types. Further, the information contained in the discovery protocol message may differ depending on the type of discovery, and an additional message may be transmitted to transmit additional information.

FIG. 4 is a diagram of an example of a protocol architecture including a discovery protocol according to the present embodiment. As illustrated in FIG. 4, a protocol stack of a discovery plane including the discovery protocol may include the Physical layer (PHY) 200 which is a radio physical layer, the Medium Access Control (MAC) 202 which is a medium access control layer, the Radio Link Control (RLC) 204 which is a radio link control layer, a Packet Data Convergence Protocol (PDCP) 206 which is a packet data convergence protocol layer, and Discovery 400 which is a discovery protocol layer. The Discovery 400 may be a protocol used to handle procedures related to discovery. An interface between UEs performing discovery may be referred to as PC5 D.

A plurality of resource pools for transmitting a message (discovery message) used in a discovery procedure may be configured, or one or more resource pools dedicated to discovery may be configured. In a case that the resource pool dedicated to discovery is configured, the UE may use the resource pool dedicated to discovery for a resource pool for transmitting a discovery message, and in a case that a resource pool dedicated to discovery is not configured, the UE may use a resource pool for sidelink communication for a resource pool for transmitting a discovery message. Note that multiple resource pools for sidelink communication may be configured together with multiple dedicated resource pools for discovery. Each resource pool may be configured by dedicated signaling for UE or may be preconfigured.

A direct communication request (DCR) message will also be described. The direct communication request message may be a message that is used to establish a unicast link. The DCR message may include at least a source UE identifier, and may include a target UE identifier in a case that the target UE identifier is provided by the application layer, and may include other information, such as information related to security and information related to the application. Further, the DCR message may be transmitted by unicast or broadcast using the source L2 ID and the destination L2 ID. The discovery message and the DCR message may be messages, the sidelink transmission of which is to be performed.

In each unicast PC5-RRC connection, a signaling radio bearer (SRB) for sidelink may be configured. The SRB for sidelink used to transmit the PC5-S message before the PC5-S security is established may be referred to as SL-SRB0. The SRB for sidelink used to transmit the PC5-S message for establishing the PC5-S security may be referred to as SL-SRB1. In addition, the sidelink SRB used to transmit a protected PC5-S message after PC5-S security is established may be referred to as SL-SRB2. In addition, the sidelink SRB used to transmit a protected PC5-RRC signalling after the PC5-S security is established may be referred to as SL-SRB3. In addition, the sidelink SRB used to transmit and/or receive a discovery message in the NR may be referred to as SL-SRB4. The PC5-RRC signalling may be RRC signalling between UEs transmitted and/or received on PC5. The PC5-RRC signalling may be referred to as a PC5-RRC message or the like.

UE-to-UE relay may be a technology in which a source UE communicates with a destination UE via sidelink communication with a relay UE in a case that the source UE communicates with the destination UE. Further, the relay UE may have a function and/or role of transferring (or relaying) data for the destination UE received from the source UE to the destination UE. The source UE, destination UE, and relay UE may be called by different names. For example, the source UE and destination UE may be called remote UE, U2U remote UE, or the like, and the relay UE may be called U2U relay UE or the like. The term UE-to-UE relay may also be called U2U relay. Also, the name “remote UE” may be replaced with the name “end UE.”

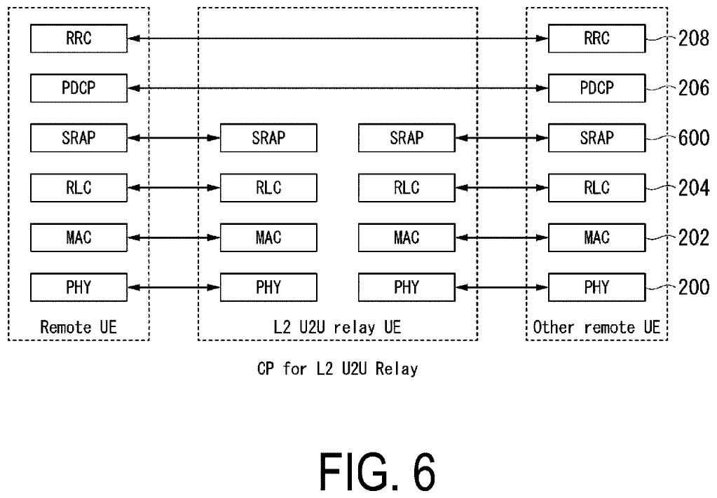

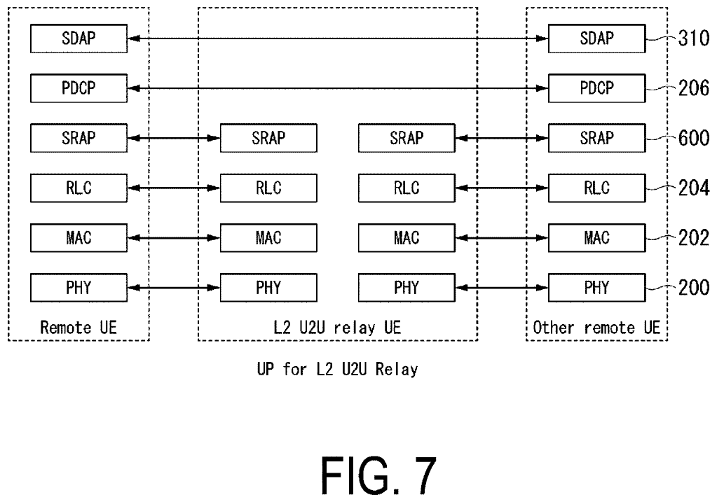

FIGS. 6 and 7 show examples of a protocol stack of a control plane (CP) and user plane (UP) in a layer 2(L2 ) UE-to-UE (U2U) relay. As shown in FIGS. 6 and 7, an SRAP 600 may be present. The SRAP 600 may be called a sidelink relay adaptation protocol layer (SRAP layer), an SRAP layer, or the like, or a different name may be used. As shown in FIGS. 6 and 7, PHY 200, MAC 202, RLC 204, and SRAP 600 may be associated between the remote UE and an L2 U2U relay UE, and between an L2 U2U relay UE and the other remote UE, and PDCP 206, RRC 208, and SDAP 310 may be associated between the remote UE and the other remote UE. As shown in FIG. 2, PC5-S 210 may be used instead of RRC 208 to control a PC5 connection between the remote UE and the other remote UE (not shown). In the protocol stack in Layer 3(L3 ) UE-to-UE relay, PHY 200, MAC 202, RLC 204, PDCP 206, RRC 208, and SDAP 210 may be associated between the remote UE and the U2U relay UE and between the U2U relay UE and the other remote UE, and SRAP 600 need not be configured (not shown). In an L3 U2U relay, a higher layer than SDAP may have a function of transmitting, on a PC5 link, data received on a Uu link. The SRAP layer may be included in an AS layer.

Here, the SRAP layer will be described. The SRAP layer may be called an SRAP sublayer, or simply SRAP. The SRAP sublayer may be present above an RLC sublayer for the control plane and user plane of the PC5 interface, and may be present below the PDCP sublayer for the control plane and user plane of the PC5 interface. The SRAP sublayer on the PC5 may be used for a bearer mapping purpose. In an L2 U2U relay UE, the SRAP sublayer may include one SRAP entity on the PC5 interface between the source UE and the relay UE, and may include a separate collocated SRAP entity on the PC5 interface between the relay UE and the destination UE. In an L2 U2U remote UE, the SRAP sublayer may include only one SRAP entity on one PC5 interface. An SRAP entity associated between the remote UE and the relay UE via the PC5 interface may be specifically referred to as PC5-SRAP. Each SRAP entity may include a transmitter and a receiver. On the PC5 interface, the transmitter of the SRAP entity of the L2 U2U remote UE may be associated with the receiver of the SRAP entity of the L2 U2U relay UE, and the receiver of the SRAP entity of the L2 U2U remote UE may be associated with the transmitter of the SRAP entity of the L2 U2U relay UE.

Further, the SRAP entity may have a function of transferring data, a function of determining a UE ID field and a bearer ID field of an SRAP header to be added to a data packet, a function of determining an egress link, and a function of determining an egress RLC channel. In addition, the SRAP entity may have other functions.

Also, in a case that the remote UE transmits data for a sidelink to the other remote UE, the remote UE may be referred to as a source UE, and the other remote UE may be referred to as a destination UE. Similarly, in the reverse case, in a case that the other remote UE transmits the data for a sidelink to the remote UE, the other remote UE may be referred to as a source UE, and the remote UE may be referred to as a destination UE. The source UE may be referred to as a source remote UE, simply as the remote UE, or may be interchangeable. In addition, the destination UE may be referred to as, for example, a destination remote UE, may be simply referred to as a remote UE, may be referred to as a target UE, or may be interchangeable. The source UE and the destination UE may be specified by different names, or may be referred to as, for example, a U2U source UE, a U2U destination UE in order to clarify that the UEs are terminals performing U2U relay. In addition, in order to clarify that the UEs perform communication through the L2 U2U relay, the UEs may be referred to as, for example, an L2 U2U source UE or an L2 U2U destination UE and, similarly, in order to clarify that the UEs communicate through the L3 U2U relay, the UEs may be referred to as, for example, an L3 U2U source UE or an L3 U2U destination UE. Not only in a case that either the remote UE or the other remote UE transmits data for the sidelink, but also in a case that a set of U2U relays (a set of one remote UE, one relay UE, and the other remote UE) is configured, the UE that transmits a discovery message first other than the U2U relay UE may be called a source UE, the UE that is neither a source UE nor the U2U relay UE in the U2U relay may be called a destination UE, and names such as the source UE and destination UE may be used simply to distinguish between two remote UEs.

Further, the UE may transmit a discovery message and/or a direct communication request message to perform a U2U relay. For example, to select a relay UE for U2U relay, the source UE may transmit the discovery message or the direct communication request message. The discovery in this case may be discovery of Model B. A UE (a candidate of the relay UE) that receives the discovery message or direct communication request message transmitted from the source UE may transmit the discovery message or direct communication request message to the destination UE. Also, the UE (the candidate of the relay UE) may transmit the discovery message and/or the direct communication request message to the source UE. The discovery in this case may be discovery of Model A.

In the sidelink, a reference signal received power (RSRP) measured by the UE may be, for example, the following RSRP.
(a) PSBCH RSRP
(b) PSSCH RSRP
(c) PSCCH RSRP

The PSBCH-RSRP (PSBCH RSRP) may be defined as a linear average of power contributions of resource elements that transmit a plurality of demodulation reference signals (DMRS) associated with the PSBCH. The PSSCH-RSRP (PSSCH RSRP) may be defined as a linear average of power contributions of resource elements of antenna ports transmitting multiple DMRSs associated with the PSSCH, and in a case that there are multiple antenna ports, values of RSRP for each antenna port may be summed. The PSCCH-RSRP (PSCCH RSRP) may be defined as a linear average of power contributions of resource elements carrying multiple DMRS associated with the PSCCH. Note that the DMRS may be used to demodulate, for example, signals of the PSBCH, the PSSCH, and the PSCCH. Further, a terminal apparatus performing sidelink communication with another terminal apparatus may measure the RSRP of the sidelink communication (SL-RSRP) using the PSSCH or PSCCH transmitted from the other terminal apparatus. Further, the terminal apparatus may measure the RSRP of the discovery message (SD-RSRP) using the power contributions of resource elements transmitting DMRS associated with the PSSCH carrying the discovery message.

In addition, in measurements in the sidelink, the UE 122 may measure the following quantities in addition to the above-described RSRP.
(a) Sidelink received signal strength indicator (SL RSSI)
(b) Sidelink channel occupancy ratio (SL CR)
(c) Sidelink channel busy ratio (SL CBR)

The SL RSSI may be defined as a linear average of the power ([W]) observed on configured subchannels in the OFDM symbols of slots configured for PSCCH and PSSCH, starting from a second OFDM symbol. Further, the SL CR in slot n may be defined as a sum of the number of subchannels used for sidelink transmission from slot [n−a] to slot [n−1] and the number of subchannels allocated from slot [n] to slot [n+b] divided by a total number of subchannels configured from slot [n−a] to slot [n+b]. Further, the SL CBR in slot n may be defined as a percentage of subchannels in the resource pool whose SL RSSI exceeds a threshold during a period configured as a CBR measurement window (slot [n−a] to slot [n−1]).

There are two resource allocation modes in the NR sidelink communication, a mode in which the UE performs the sidelink transmission using resources scheduled by a base station is called mode 1, and a mode in which the UE automatically selects resources and performs the sidelink transmission is called mode 2. In Mode 1, the UE needs to be RRC_CONNECTED, and in Mode 2, the UE is capable of sidelink transmission regardless of the RRC state or whether the UE is inside or outside the NG-RAN. In Mode 2, the UE automatically selects a resource capable of sidelink transmission from one or multiple resource pools configured before sidelink transmission is performed.

An operation of the SDAP entity on a transmission side in the sidelink communication will be described. In a case that an SDAP SDU for a certain PC5 QoS flow is received from a higher layer (such as an application layer), the SDAP entity on the transmission side maps the SDAP SDU to a default SL-DRB in a case that a mapping rule between the PC5 QoS flow and the SL-DRB for the PC5 QoS flow is not stored, and the SDAP entity on the transmission side maps the SDAP SDU to the SL-DRB according to the mapping rule in a case that the mapping rule between the PC5 QoS flow and the SL-DRB for the PC5 QoS flow is stored. In addition, the SDAP entity on the transmission side constructs an SL SDAP data PDU with an SDAP header in a case that the SDAP header is configured by the RRC to exist in the SL-DRB to which the SDAP SDU is mapped, and constructs an SL SDAP data PDU without an SDAP header in a case that the SDAP header is not configured by the RRC to exist in the SL-DRB to which the SDAP SDU is mapped. In addition, the SDAP entity on the transmission side presents the constructed SL SDAP PDU to a lower layer (such as a PDCP layer).

Operation of the SDAP entity on the reception side in the sidelink communication will be described. In a case that an SDAP data PDU for a certain PC5 QOS flow is received from a lower layer (such as the PDCP layer), the SDAP entity on the reception side acquires the SDAP SDU from the SL SDAP data PDU with an SDAP header in a case that the SDAP header is configured by the RRC to exist in the SL-DRB that has received the SL SDAP data PDU, and acquires the SDAP SDU from the SL SDAP data PDU without an SDAP header in a case that the SDAP header is not configured by the RRC to exist in the SL-DRB that has received the SL SDAP data PDU. Further, the SDAP entity on the reception side passes the acquired SDAP SDU to a higher layer (such as the application layer).

Next, mapping between PC5 QoS flow and SL-DRB will be described. In a case that the RRC configures the mapping between the PC5 QOS flow and the SL-DRB for a PC5 QoS flow, the SDAP entity generates an end marker control PDU for the PC5 QOS flow, maps the end marker control PDU to the default SL-DRB, and submits the end marker control PDU to a lower layer (for example, the PDCP layer) in a case that (1) the SDAP entity is already established, (2) a mapping rule for the SL-DRB for the PC5 QoS flow is not stored, and (3) the default SL-DRB is configured, for unicast NR sidelink communication. In addition, in a case that the RRC configures the mapping between the PC5 QoS flow and the SL-DRB for the PC5 QoS flow, the SDAP entity generates an end marker control PDU for the PC5 QOS flow, maps the end marker control PDU to the SL-DRB that complies with the stored mapping rule, and submits the end marker control PDU to a lower layer (for example, the PDCP layer) in a case that (1) a stored mapping rule for the PC5 QoS flow and the SL-DRB is different from the configured mapping rule for the PC5 QOS flow and the SL-DRB, and (2) an SL SDAP header is configured by the RRC to be present in the SL-DRB that follows the stored mapping rule, for unicast of the NR sidelink communication. Further, the SDAP entity stores a mapping rule between the PC5 QoS flow and the SL-DRB configured for the PC5 QoS flow. In a case that the RRC releases the mapping rule between the PC5 QoS flow and the SL-DRB for a certain PC5 QoS flow, the SDAP entity deletes the mapping rule. Further, in a case that the RRC indicates that a certain SL-DRB is to be released, the SDAP entity releases all mapping rules between the PC5 QOS flow and the SL-DRB related to the SL-DRB.

The header assigned to the SL SDAP data PDU may include information indicating that the SDAP PDU is an SDAP data PDU and information indicating the identifier (PQFI or PFI: PC5 QoS flow ID) of the PC5 QoS flow to which the SL SDAP data PDU belongs. In addition, the end marker control PDU may be a control PDU that is used by the SDAP entity to indicate that the mapping of the SDAP SDU of the PC5 QoS flow indicated by the PQFI and the end marker control PDU to the SL-DRB on which the end marker control PDU is transmitted is stopped. The header assigned to the end marker control PDU may include information indicating that the SDAP PDU is an SDAP control PDU and the PQFI.

Further, the PC5 QoS flow is the finest granularity of QoS transfer processing in the sidelink, and all traffic (data) mapped to the same PC5 QoS flow receives the same transfer processing (scheduling policy, queue management policy, rate shaping policy RLC configuration, or the like). A different PC5 QOS flow is required to provide a different transfer processing. Also, the PC5 QOS flow is associated with a PC5 QoS rule and PC5 QoS parameters. Further, the PC5 QoS parameters include PQI (PC5 5QI (5G QOS Identifier)), PC5 Flow Bit Rates, PC5 Link Aggregated Bit Rates, Range, Default Value, and the like. The PQI is used as a reference for PC5 QOS characteristics, that is, parameters for controlling the QoS transfer processing for packets via PC5, and the PC5 QoS characteristics include a resource type, priority level, packet delay budget (PDB), packet error rate (PER), averaging window, maximum data burst volume, and the like. Here, the PDB indicates an upper limit of a packet delay time between a transmission UE and a reception UE on a PC5. Further, the UE may associate traffic (data) with a QoS flow based on a QoS rule.

The UE that has received a packet from the application layer determines whether or not there is a PC5 QoS flow matching the packet based on the PC5 QoS rule, determines the PC5 QOS parameters according to the requirements in a case that the UE determines that there is no PC5 QoS flow and requirements are provided from the application layer, and determines the PC5 QOS parameters according to the mapping between the type of service and the PC5 QoS parameters in a case that there are no requirements. In a case that there is no PC5 QOS flow satisfying the determined PC5 QoS parameters, the UE that has determined the PC5 QoS parameters creates a new PC5 QOS flow satisfying the determined PC5 QoS parameters, assigns a PFI and a PC5 QOS rule to the new PC5 QoS flow, and updates a PC5 packet filter set of a PC5 QOS flow satisfying the determined PC5 QoS parameters in a case that there is the PC5 QoS flow.

Based on the above description, a variety of the present embodiments will be described. The above-described processing may be applied with respect to the corresponding processing omitted in the following description.

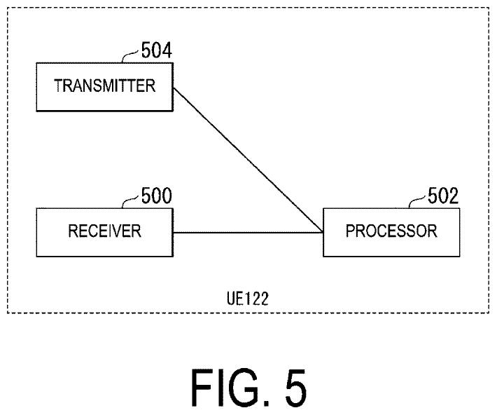

FIG. 5 is a block diagram illustrating a configuration of a terminal apparatus (UE 122) in the present embodiment. FIG. 5 illustrates only the main components closely related to the present embodiment in order to avoid complexity of description.

The UE 122 shown in FIG. 5 includes a receiver 500 that receives control information (SCI, MAC control element, RRC signalling, and the like.), discovery message, information including user data, and the like from the other terminal apparatus, a processor 502 that performs processing according to parameters included in the received control information or the like, and a transmitter 504 that transmits control information (SCI, MAC control element, RRC signalling, and the like.), discovery message, information including user data, or the like to the other terminal apparatus. In addition, the processor 502 may include some or all of functions of various layers (for example, physical layer, MAC layer, RLC layer, PDCP layer, SRAP layer, SDAP layer, RRC layer, PC5-S layer, discovery layer, and application layer). That is, the processor 502 may include some or all of a physical layer processor (PHY processor), a MAC layer processor (MAC processor), an RLC layer processor (RLC processor), a PDCP layer processor (PDCP processor), an SRAP layer processor (SRAP processor), an SDAP layer processor (SDAP processor), an RRC layer processor (RRC processor), a PC5-S layer processor (PC5-S processor), a discovery layer processor (discovery processor), and an application layer processor. A part of the application layer may include a ProSe layer, a V2X layer, and the like, and an application layer that provides services to the ProSe layer, the V2X layer, or the like may exist above the ProSe layer or the V2X layer.

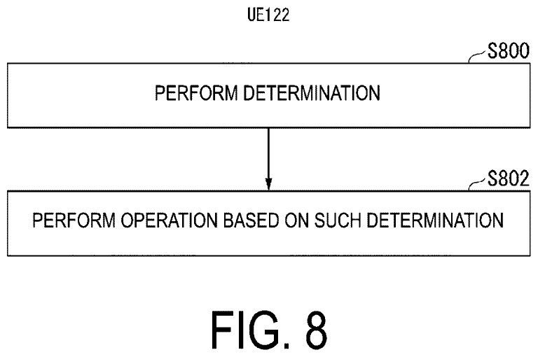

An example of an embodiment in an aspect of the present invention is shown with reference to FIG. 8.

The UE 122 capable of the sidelink communication performs a determination based on data received from the higher layer in step S800, and transmits first information to the first terminal apparatus based on the determination in step S802.

In step S800, the data may be an SDAP SDU for a certain PC5 QoS flow. In addition, in step S800, the UE 122 may perform some or all of the following determinations.
(C-a) A mapping rule between the PC5 QoS flow and SL-DRB exists.
(C-b) The UE 122 plays a role of an L2 U2U remote UE.

In a case that it is determined that both the conditions (C-a) and (C-b) are satisfied, and in a case that it is determined that the condition (C-a) is satisfied and the condition (C-b) is satisfied, the UE 122 need not transmit the first information in step S802, and in a case that it is determined that the condition (C-a) is not satisfied and the condition (C-b) is satisfied, the UE 122 may transmit the first information. The first information may include, for example, some or all of the following information.
(I-a) Information for identifying the PC5 QoS flow (for example, PFI or PQFI)
(I-b) Mapping rule between the PC5 QoS flow and SL-DRB configured by the UE 122
(I-c) PQI to be mapped to the PC5 QOS flow
(I-d) Identifier for identifying the UE 122
(I-e) Mapping rule between the SL-DRB and the RLC channel (PC5 relay RLC channel) of the UE 122

For example, the first terminal apparatus that has received the first information may map the SL-DRB and the RLC channel in consideration of the mapping rule between the PC5 QoS flow and the SL-DRB. The SL-DRB may be an SL-DRB of End-to-End (E2E) that is terminated at a second terminal via the first terminal apparatus from the UE 122, and the RLC channel may be an RLC channel that is used for the first terminal apparatus to transmit data from the UE 122 to the second terminal apparatus. In addition, the RLC channel may be called a PC5 relay RLC Channel or may be called another name. In addition, in a case that the first terminal apparatus cannot map the SL-DRB to the RLC channel in consideration of the mapping rule between the PC5 QOS flow and the SL-DRB, that is, in a case that it is determined that a transfer satisfying QOS cannot be performed, the first terminal apparatus may transmit information indicating that the mapping between the SL-DRB and the RLC channel cannot be performed to the UE 122, and in a case that the mapping between the SL-DRB and the RLC channel is performed in consideration of the mapping rule between the PC5 QoS flow and the SL-DRB, that is, in a case that it is determined that a transfer satisfying QOS can be performed, the first terminal apparatus may transmit information indicating that the mapping between the SL-DRB and the RLC channel has been performed to the UE 122, or may transmit information indicating whether the mapping between the SL-DRB and the RLC channel has been performed to the UE 122.

In addition, the first terminal apparatus that has performed the mapping between the SL-DRB and the RLC channel may transmit data including information for identifying the SL-DRB to the second terminal apparatus via the RLC channel.

The first terminal apparatus may determine whether or not the mapping between the SL-DRB and the RLC channel can be performed in consideration of the mapping rule between the PC5 QoS flow and the SL-DRB, based on path quality between the first terminal apparatus and the UE 122 and between the first terminal apparatus and the second terminal apparatus. The path quality may be a sidelink channel busy ratio (SL CBR), may be reference signal received power (RSRP), may be a path loss (SL), may be a modulation scheme and coding rate (MCS: Modulation Coding Scheme) used for sidelink transmission, or may be determined based on other information.

The UE 122 may configure the mapping between the PC5 QoS flow and the SL-DRB, and may also configure a mapping rule between the SL-DRB and the RLC channel (PC5 Relay RLC channel) of the UE 122. In a case that the mapping rule between the SL-DRB and the RLC channel is configured, the configuration regarding the mapping rule between the SL-DRB and the RLC channel may be transmitted to the first terminal apparatus.

Furthermore, for example, the first terminal apparatus that has received the first information may transmit to the UE 122 a mapping rule between the SL-DRB and the PC5 QoS flow that satisfies QoS, that is, a configuration of the SDAP layer. In addition, the first terminal apparatus may transmit the mapping rule between the SL-DRB and the RLC channel, that is, a configuration of the SRAP layer to the UE 122. The UE 122 receiving the configuration of the SDAP layer of the UE 122 may configure the SDAP layer according to the configuration of the SDAP layer and transmit data for the PC5 QoS flow according to the mapping rule. The PC5 QoS flow may be mapped to an SL-DRB already configured in the UE 122, or a new SL-DRB may be established for the PC5 QoS flow and the PC5 QoS flow may be mapped to the established SL-DRB. The configuration of the SDAP layer and/or the configuration of the SRAP layer may be transmitted to the UE 122 by the RRC message (such as RRC Reconfiguration Sidelink).

Furthermore, the first terminal apparatus that has received the first information may configure a remaining PDB in the RLC channel or logical channel to which the SL-DRB is mapped, based on the mapping rule between the PC5 QoS flow and the SL-DRB. In addition, the remaining PDB may be configured based on a PC5 QoS rule or PC5 QoS parameter associated with the PC5 QoS flow, and the remaining PDB may be configured based on the number of relay nodes (U2U relay UEs) present between the UE 122 and the second terminal apparatus. The first terminal apparatus may select resources to be used for sidelink transmission in consideration of the remaining PDB.

Furthermore, in a case that the UE 122 transmits the data to the first terminal apparatus, the UE 122 may transmit information on the remaining PDB associated with the data. For example, the information on the remaining PDB may be added to the data as an information element of the SRAP layer, or may be included in a transport block including the data as a MAC CE. The first terminal apparatus that has received the information on the remaining PDB may determine the remaining PDB to be used for transmission of the data based on the information on the remaining PDB.

The UE 122 may transmit and/or receive information on the PC5 QoS flow to be added when establishing or modifying the PC5 unicast link (and Layer-2 link) with the peer terminal apparatus to and/or from the peer terminal apparatus. The information on the PC5 QOS flow may be, for example, information such as the PFI of the PC5 QoS flow to be added, PC5 QoS parameters (including at least PQI) corresponding to the PFI, and a service type. Further, the UE 122 may negotiate the PC5 QoS with the peer terminal apparatus to determine the PC5 QoS.

The first terminal apparatus may be an L2 U2U relay UE, and the UE 122 and the second terminal apparatus may be L2 U2U remote UE. Further, the UE 122 may communicate with the second terminal apparatus via the first terminal apparatus, and the UE 122 may communicate with the second terminal apparatus via the first terminal apparatus and a plurality of other terminal apparatuses. The plurality of other terminal apparatuses may have a function of performing the same operation as the first terminal apparatus.

In each example, the first terminal apparatus, the second terminal apparatus, and other terminal apparatuses may be terminal apparatuses capable of sidelink communication, similar to the UE 122, and may be terminal apparatuses having a configuration including a receiver, a processor, and a transmitter, or may be called by other names.

PC5 QoS processing of the related art in NR does not assume that data is relayed by the UE, and in a case that the data is relayed, data transmission satisfying PC5 QoS is likely to be unable to be performed. According to an aspect of the present invention, even in a case that the data is relayed by the UE, transmission can be performed in consideration of end-to-end PC5 QoS.

Furthermore, in the above description, expressions such as “notified” and “indicated” may be interchangeable.

Further, in the above description, expressions such as “link”, “map”, and “associate” may be interchangeable.

In the above description, expressions such as “included”, “being included”, and “was included” may be interchangeable.

Further, in the above description, “the” may be interchangeable with “the above-described”.

Further, in the above description, expressions such as “determined to be”, “is configured”, and “is included” may be interchangeable.

Further, in the example of each processing or the example of the flow of each processing in the above description, some or all of the steps need not be performed. In the example of each processing or the example of the flow of each processing in the above description, an order of the steps may be different from each other. In the example of each processing or the example of the flow of each processing in the above description, a part or all of the processing in each step need not be performed. In the example of each processing or the example of the flow of each processing in the above description, an order of processing in each step may be different from each other. In the above description, “to perform B based on satisfaction of A” may be replaced with “to perform B”. In other words, “to perform B” may be performed independently of “satisfaction of A”.

In the above description, “A may be rephrased as B” may include the meaning of rephrasing B as A in addition to rephrasing A as B.

In a case that the above description contains “C may be D” and “C may be E”, this means inclusion of “D may be E.” In a case that the above description contains “F may be G” and “G may be H”, this may mean inclusion of “F may be H”.

Further, in the above description, in a case that a condition “A” and a condition “B” are conflicting conditions, the condition “B” may be expressed as “another” condition of the condition “A”.

A program that operates on an apparatus according to the present embodiment may be a program that controls a central processing unit (CPU) or the like to cause a computer to function in order to realize the functions of the present embodiment. The program or information handled by the program is temporarily loaded into a volatile memory such as random access memory (RAM) during processing, or stored in a non-volatile memory such as a flash memory or a hard disk drive (HDD), and is read, modified, and written by the CPU as necessary.

The apparatus in the above-described embodiment may be partially realized by a computer. In this case, a program for implementing this control function may be implemented by recording the program in a computer-readable recording medium and causing a computer system to read and perform the program recorded in the recording medium. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Furthermore, the term “computer-readable recording medium” may also include something that dynamically holds a program for a short period of time, such as a communication line in a case that a program is transmitted via a network such as the Internet or a communication line such as a telephone line, or something that holds a program for a certain period of time, such as volatile memory within a computer system that is a server or client in that case. Furthermore, the above-described program may be configured to realize some of the functions described above, and additionally may be configured to realize the functions described above, in combination with a program already recorded in the computer system.

Furthermore, each functional block or feature of the apparatus used in the above-described embodiment may be implemented or performed by an electric circuit, typically, an integrated circuit or a plurality of integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or the processor may be a processor of known type, a controller, a micro-controller, or a state machine instead. The general-purpose processor or the above-mentioned circuits may include a digital circuit, or may include an analog circuit. Furthermore, in a case that with advances in semiconductor technology, a circuit integration technology appears that replaces the present integrated circuits, it is also possible to use an integrated circuit based on the technology.

The present embodiment is not limited to the above-described embodiment. Although apparatuses have been described as an example in the embodiment, the present embodiment is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although this embodiment has been described in detail above with reference to the drawings, the specific configuration is not limited to the embodiment, and design changes within the scope of this embodiment are also included. Furthermore, various modifications are possible within the scope of the present embodiment defined by claims, and embodiments that are made by suitably combining technical means disclosed according to the different embodiments are also included in the technical scope of the present embodiment. Further, configurations in which elements described in the embodiment having similar effects are replaced with each other are also included.

### INDUSTRIAL APPLICABILITY

An aspect of the present invention can be used, for example, in a communication system, a communication device (for example, a mobile phone device, a base station apparatus, a wireless LAN device, or a sensor device), an integrated circuit (for example, a communication chip), a program, or the like.

### REFERENCE SIGNS LIST

100 ng-eNB
102 gNB
110, 112, 114 Interface
122 UE
200 PHY
202 MAC
204 RLC
206 PDCP
208 RRC
210 PC5-S
310 SDAP
400 Discovery
500 Receiver
502 Processor
504 Transmitter
600 SRAP

1. A first terminal apparatus capable of sidelink communication, comprising:
a transmitter, wherein
the first terminal apparatus communicates with a third terminal apparatus via a second terminal apparatus by the sidelink communication,
the transmitter transmits to the second terminal apparatus mapping information of a PC5 QoS (Quality of Service) flow and an SL-DRB (Sidelink Data Radio Bearer) by the sidelink communication, and
the SL-DRB is an end-to-end SL-DRB terminated between the first terminal apparatus and the third terminal apparatus.

2. A second terminal apparatus capable of sidelink communication, comprising:
a processor;
a transmitter; and
a receiver configured to receive first information from a first terminal apparatus by the sidelink communication, wherein
the second terminal apparatus play a role of relaying communication between the first terminal apparatus and a third terminal apparatus by the sidelink communication,
the first information includes mapping information of a PC5 QOS (Quality of Service) flow and an SL-DRB (Sidelink Data Radio Bearer),
the processor maps the SL-DRB and an RLC channel of the second terminal apparatus based on the first information, and
the SL-DRB is an end-to-end SL-DRB terminated between the first terminal apparatus and the third terminal apparatus.

3. A method for a first terminal apparatus capable of sidelink communication, the method comprising:
communicating with a third terminal apparatus via a second terminal apparatus by the sidelink communication; and
transmitting to the second terminal apparatus mapping information of a PC5 QoS (Quality of Service) flow and an SL-DRB (Sidelink Data Radio Bearer) by the sidelink communication, wherein
the SL-DRB is an end-to-end SL-DRB terminated between the first terminal apparatus and the third terminal apparatus.
